(19) United States
(12) Patent Application Publication
(10) Pub. No.: US 2017/0315721 A1
(43) Pub. Date: Nov. 2, 2017

(54) Remote touchscreen interface for virtual reality, augmented reality and mixed reality devices

(71) Applicant: Timothy James Merel, Menlo Park, CA (US)

(72) Inventors: Timothy James Merel, Menol Park, CA (US); Eu-Ming Lee, Bartlett, IL (US); Tom Dubois, Palo Alto, CA (US)

(21) Appl. No.: 15/582,378

(22) Filed: Apr. 28, 2017

Related U.S. Application Data
(60) Provisional application No. 62/330,037, filed on Apr. 29, 2016.

(51) Int. Cl. G06F 3/0488; G06F 3/01

(52) U.S. Cl. CPC G06F 3/04883; G06F 3/013; G06F 3/017

(57) ABSTRACT

The invention relates to a method for inputting instructions, with remote touchscreen devices connected by network connections to virtual reality (VR), augmented reality (AR) or mixed reality (MR) devices, to change the devices' operation, having the following steps: record user inputs with the devices, change the operation of the devices, change what is displayed by the devices including movement through virtual environments and of virtual objects, and provide visual, audio, haptic or other feedback via the devices.

### RELATED U.S. APPLICATION DATA

Continuation of Provisional Patent Application No. 62/330,037 filed on Apr. 29, 2016. This application is entitled to the benefit of, and incorporates by reference essential subject matter disclosed in Provisional Patent Application No. 62/330,037 filed on Apr. 29, 2016.

### FIELD

Various of the disclosed embodiments concern a remote touchscreen interface for VR, AR and MR devices.

### BACKGROUND

VR, AR and MR devices provide an immersive user experience, but manual control of such devices is not as user friendly as that enabled by touchscreen inputs. To change a view, zoom, select from a menu, and almost any other manual, i.e. hand operated, control action is relatively cumbersome compared to touchscreen interfaces. A better human interface for AR/VR/MR devices is needed.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows a one-to-one embodiment of a remote touchscreen interface for AR/VR/MR devices according to the invention;

FIG. 2 shows a one-to-many embodiment of a remote touchscreen interface for AR/VR/MR devices according to the invention;

FIG. 3 shows a many-to-one embodiment of a remote touchscreen interface for AR/VR/MR devices according to the invention;

FIG. 4 shows a many-to-many embodiment of a remote touchscreen interface for AR/VR/MR devices according to the invention;

FIG. 5 shows a one touch embodiment of a remote touchscreen interface for AR/VR/MR devices according to the invention;

FIG. 6 shows a two touch embodiment of a remote touchscreen interface for AR/VR/MR devices according to the invention;

FIG. 7 shows a three touch embodiment of a remote touchscreen interface for AR/VR/MR devices according to the invention;

FIG. 8 shows a four touch embodiment of a remote touchscreen interface for AR/VR/MR devices according to the invention;

FIG. 9 shows a five touch embodiment of a remote touchscreen interface for AR/VR/MR devices according to the invention;

FIG. 10 shows a six touch embodiment of a remote touchscreen interface for AR/VR/MR devices according to the invention;

FIG. 11 shows a seven touch embodiment of a remote touchscreen interface for AR/VR/MR devices according to the invention;

FIG. 12 shows an eight touch embodiment of a remote touchscreen interface for AR/VR/MR devices according to the invention;

FIG. 13 shows a nine touch embodiment of a remote touchscreen interface for AR/VR/MR devices according to the invention;

FIG. 14 shows a ten touch embodiment of a remote touchscreen interface for AR/VR/MR devices according to the invention;

FIGS. 15-16 show a walking gesture in a remote touchscreen or touchpad interface for AR/VR/MR devices according to the invention;

FIGS. 17-18 show a turning gesture in a remote touchscreen interface for AR/VR/MR devices according to the invention;

FIGS. 19-25 show panning, turning, scrolling, and selection gesture in a remote touchscreen interface for AR/VR/MR devices according to the invention;

FIGS. 26-29 show combined panning and rotating gestures in a remote touchscreen interface for AR/VR/MR devices according to the invention;

FIGS. 30-31 show rotating swirl gestures in a remote touchscreen interface for AR/VR/MR devices according to the invention;

FIG. 32 shows a finger wheel gesture in a remote touchscreen interface for AR/VR/MR devices according to the invention;

FIG. 33 shows a static touch and dynamic HMD gesture in a remote touchscreen interface for AR/VR/MR devices according to the invention;

FIG. 34 shows a static touch, dynamic touchscreen and dynamic HMD gesture in a remote touchscreen interface for AR/VR/MR devices according to the invention;

FIG. 35 shows a dynamic touch and dynamic HMD gesture in a remote touchscreen interface for AR/VR/MR devices according to the invention;

FIG. 36 shows a dynamic touch, dynamic touchscreen and dynamic HMD gesture in a remote touchscreen interface for AR/VR/MR devices according to the invention;

FIG. 37 shows a dynamic touch, dynamic touchscreen and static HMD gesture in a remote touchscreen interface for AR/VR/MR devices according to the invention;

FIG. 38 shows touchscreen to device pairing via networks in a remote touchscreen interface for AR/VR/MR devices according to the invention;

FIG. 39 shows touchscreen to device control via networks in a remote touchscreen interface for AR/VR/MR devices according to the invention; and

FIG. 40 shows a diagrammatic representation of a machine in the example form of a computer system within which a set of instructions for causing the machine to perform one or more of the methodologies discussed herein may be executed.

FIG. 41 shows a flowchart of an embodiment of an inventive method.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### Remote Touchscreen Interface for AR/VR/MR Devices

Embodiments of the invention (the “System”) enable touch screen hardware (“Touchscreen”) to interface with VR, AR and MR hardware devices (“Device” or “Devices”).

Devices include but are not limited to VR, AR and MR head mounted displays, heads up displays, sensors, accelerometers, compasses, cameras, controllers, central processing units (“CPU”), graphics processing units, visual processing units, firmware, digital memory in the form of RAM, ROM or otherwise, communication network components, whether Bluetooth, Wi-Fi, cellular mobile network or otherwise, and any other components included in or operating in conjunction with VR, AR and MR systems of any type.

Touchscreens include but are not limited to smartphones, tablet computers, smart watches, automotive touchscreens, personal computers, television screens, game consoles and any other device using a touchscreen.

The System enables VR, AR and MR Users (“Users”) to use one or more Touchscreens to manipulate one or more Devices or Touchscreens, and one or more Devices to manipulate one or more Touchscreens or Devices (“Manipulate” or “Manipulation”), including but not limited to:

selecting, activating, inserting, removing, moving, rotating, expanding, and shrinking virtual objects displayed by Devices;

changing what is displayed by Devices;

moving Users through virtual scenes displayed by Devices; and/or

providing visual, audio, haptic and other feedback to users via Touchscreens and/or Devices.

The System is intended to make it easier and more natural for Users to use VR, AR and MR hardware and applications using Touchscreens.

In the embodiments throughout this disclosure, the word “finger” can be used interchangeably with any other physical object used to touch a touchscreen, such as stylus, pen, wand or otherwise.

### Embodiments 1 to 4—Number of Touchscreens and Devices

### Embodiment 1—One to One

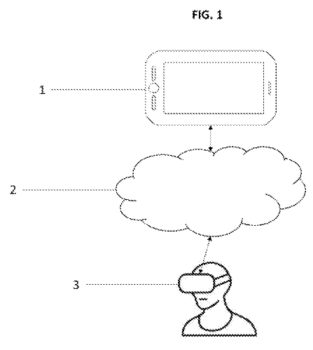

Referencing FIG. 1, the System enables Users to use a Touchscreen 1 to Manipulate a Device 3 connected by network connections 2 via Bluetooth, Wi-Fi, cellular network or any other network. The System enables multi-directional interactions between Touchscreens and Devices, with user input and feedback via images, audio, haptic, and other feedback on both Touchscreens and Devices.

### Embodiment 2—One to Many

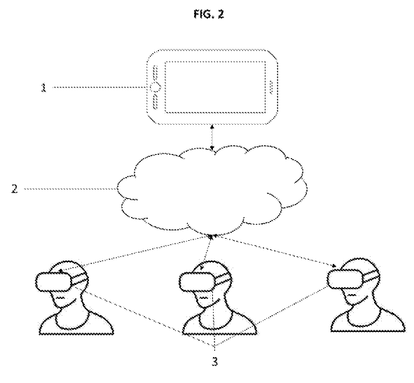

Referencing FIG. 2, the System enables Users to use a Touchscreen 1 to Manipulate two or more Devices 3 connected by network connections 2 via Bluetooth, Wi-Fi, cellular network or any other network. The System enables multi-directional interactions between Touchscreens and Devices, with user input and feedback via images, audio, haptic and other feedback on both Touchscreens and Devices.

### Embodiment 3—Many to One

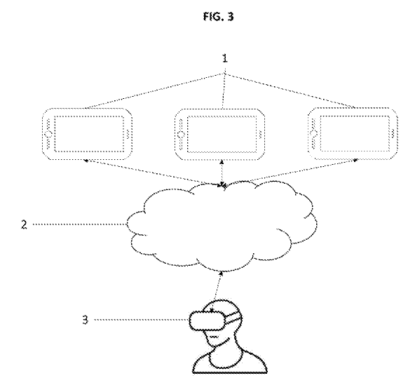

Referencing FIG. 3, the System enables Users to use two or more Touchscreens 1 to Manipulate a Device 3 connected by network connections 2 via Bluetooth, Wi-Fi, cellular network or any other network. The System enables multi-directional interactions between Touchscreens and Devices, with user input and feedback via images, audio, haptic and other feedback on both Touchscreens and Devices.

### Embodiment 4—Many to Many

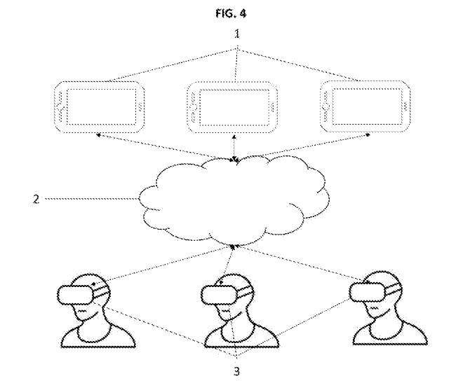

Referencing FIG. 4, the System enables Users to use two or more Touchscreens 1 to Manipulate two or more Devices 3 connected by network connections 2 via Bluetooth, Wi-Fi, cellular network or any other network. The System enables multi-directional interactions between Touchscreens and Devices, with user input and feedback via images, audio, haptic and other feedback on both Touchscreens and Devices.

### Embodiments 5 to 14—Number of Fingers Used on Touchscreens

### Embodiment 5—One Touch

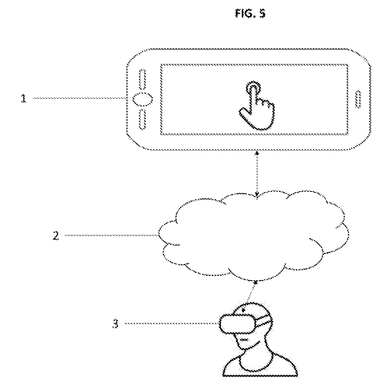

Referencing FIG. 5, the System enables Users to use a single finger touching one or more Touchscreens 1 to Manipulate one or more Devices 3 connected by network connections 2 via Bluetooth, Wi-Fi, cellular network or any other network. The finger can be from either left or right hand and can include the user's thumb.

### Embodiment 6—Two Touch

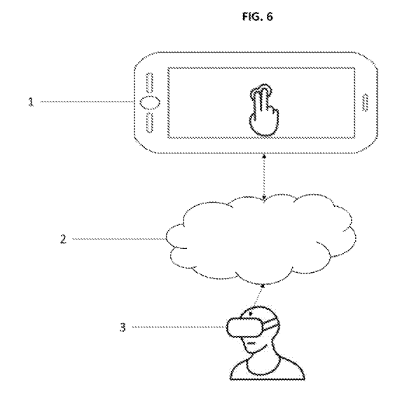

Referencing FIG. 6, the System enables Users to use two fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 7—Three Touch

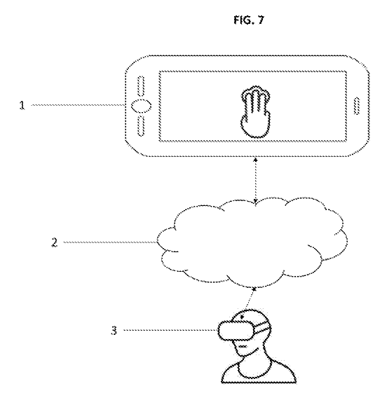

Referencing FIG. 7, the System enables Users to use three fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 8—Four Touch

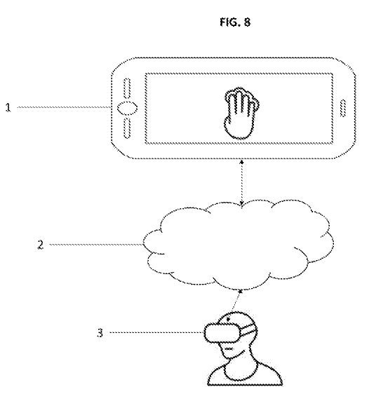

Referencing FIG. 8, the System enables Users to use four fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 9—Five Touch

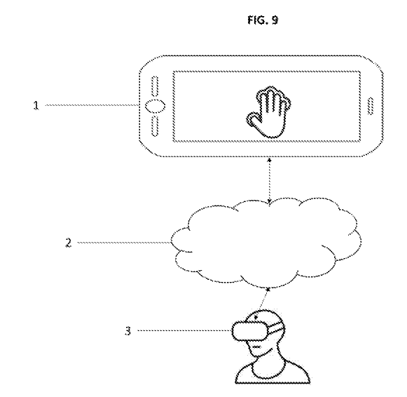

Referencing FIG. 9, the System enables Users to use five fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 10—Six Touch

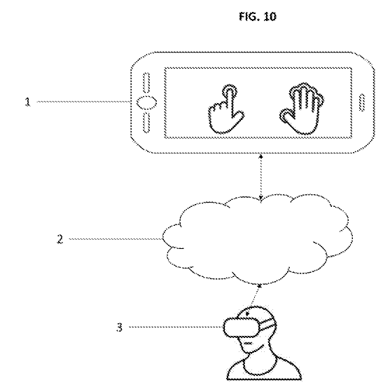

Referencing FIG. 10, the System enables Users to use six fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 11—Seven Touch

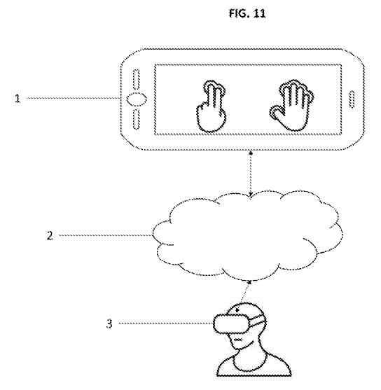

Referencing FIG. 11, the System enables Users to use seven fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 12—Eight Touch

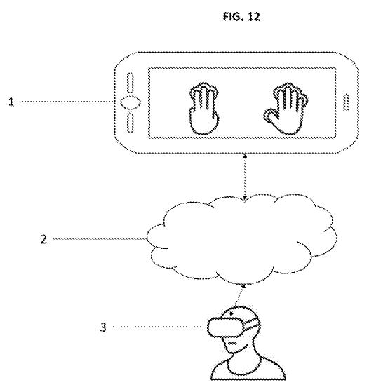

Referencing FIG. 12, the System enables Users to use eight fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 13—Nine Touch

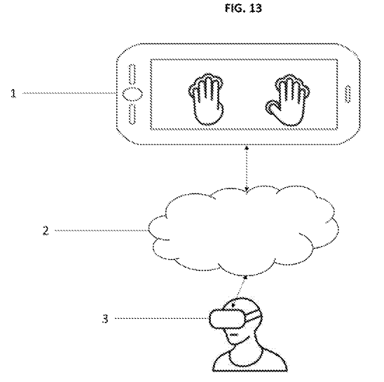

Referencing FIG. 13, the System enables Users to use nine fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiment 14—Ten Touch

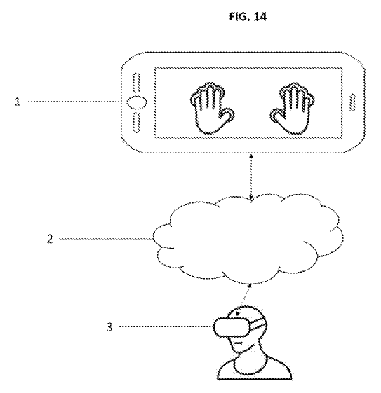

Referencing FIG. 14, the System enables Users to use ten fingers touching one or more Touchscreens 1 to Manipulate one or more Devices 3 connected by network connections 2 via Bluetooth, Wi-Fi, cellular network or any other network. The fingers can be from either left, right or both hands, and can include the user's thumbs.

### Embodiments 100 to 105—Touch Gestures

The following discussion concerns finger gestures on Touchscreens. For purposes of the discussion herein, finger gestures on Touchscreens can be distinguished from actions, and may produce different actions based on application context.

### Embodiment 100—Walking Gesture

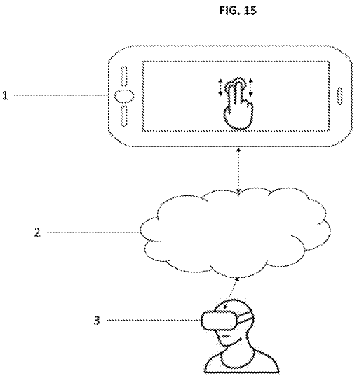

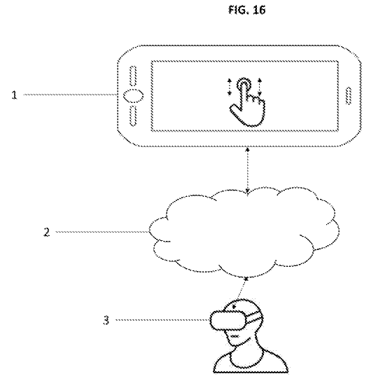

Referencing FIG. 15 and FIG. 16, the System enables Users to use one or two fingers touching one or more Touchscreens or touchpads 1 to Manipulate one or more Devices 3 connected by network connections 2 via Bluetooth, Wi-Fi, cellular network or any other network to use a simulated walking motion using one or two fingers on Touchscreens or touchpads to change what is displayed in Devices (“Walking Gesture”). The Walking Gesture includes but is not limited to alternate two finger, parallel (or close to parallel) swipes or single finger swipes in a similar direction on Touchscreens or touchpads, with the Device showing apparent forward or backward motion relative to what is being displayed in the Device in a direction corresponding to the direction of the finger swipes on Touchscreens or touchpads and/or the direction of the Device relative to what is being displayed by the Device. The fingers can be from either left, right or both hands, and can include the user's thumbs.

### Embodiment 101—Turning Gesture

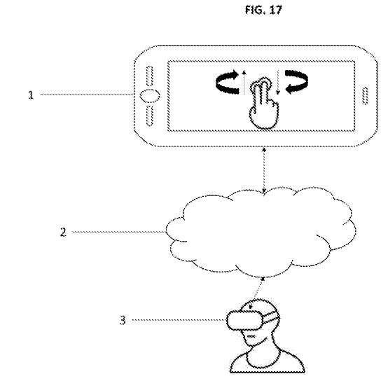

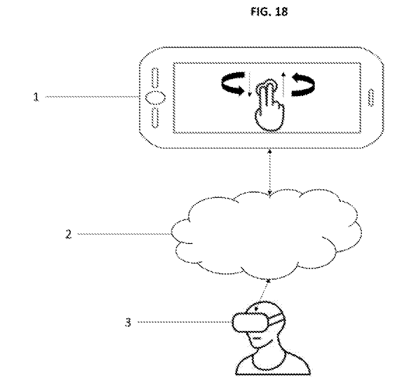

Referencing FIG. 17 and FIG. 18, the System enables Users to use two fingers touching one or more Touchscreens 1 to Manipulate one or more Devices 3 connected by network connections 2 via Bluetooth, Wi-Fi, cellular network or any other network to use a motion of two fingers in opposite directions on Touchscreens to change what is displayed in Devices (“Turning Gesture”). The Turning Gesture includes but is not limited to two fingers, parallel (or close to parallel), or clockwise or counterclockwise rotating, swipes in opposite directions on Touchscreens, with the Device showing apparent turning motion relative to what is being displayed in the Device in a direction corresponding to the opposing direction of the finger swipes on Touchscreens. The fingers can be from either left, right or both hands, and can include the user's thumbs.

### Embodiment 102—Panning, Turning, Scrolling or Selection Gesture

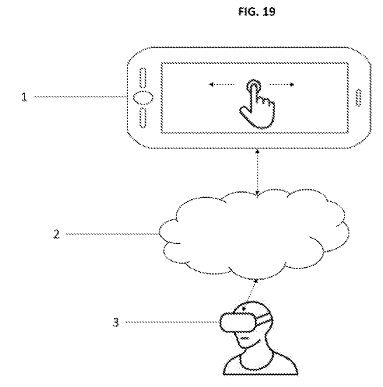

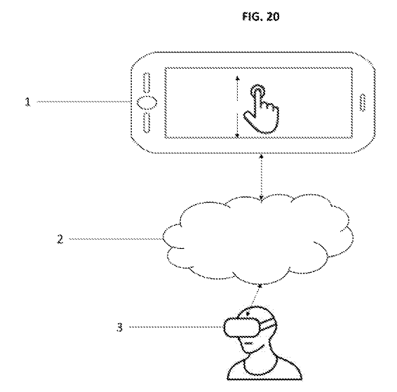

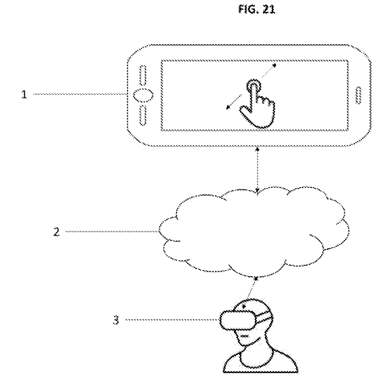

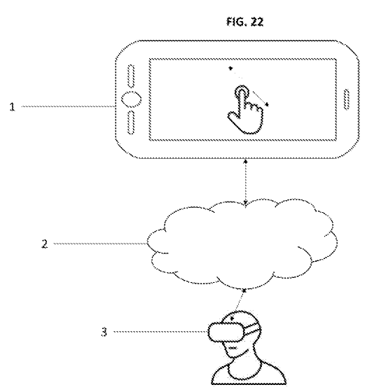

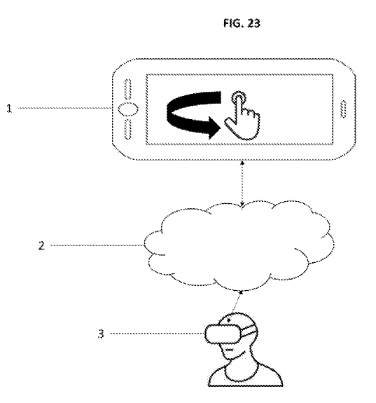

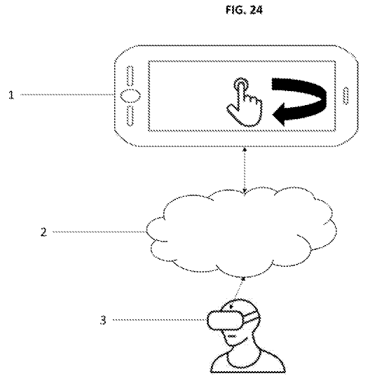

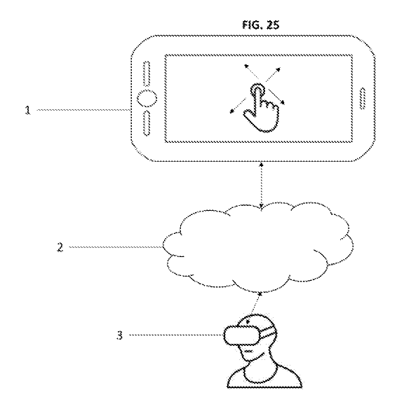

Referencing FIG. 19, FIG. 20, FIG. 21, FIG. 22, FIG. 23, FIG. 24 and FIG. 25, the System enables Users to use one or more fingers touching one or more Touchscreens 1 to Manipulate one or more Devices 3 connected by network connections 2 via Bluetooth, Wi-Fi, cellular network or any other network to use a swiping motion of one or more fingers to change what is displayed in Devices (“Panning, Turning, Scrolling or Selection Gesture”). The Panning, Turning, Scrolling or Selection Gesture includes but is not limited to one or more fingers swiping in any direction or combination of directions on Touchscreens, with the Device showing apparent panning of, turning in, scrolling towards or away from, selection of or other actions in relation to the direction(s) that the User sees relative to what is being displayed in the Device in direction(s) corresponding to the direction(s) of the finger swipes on Touchscreens. The Panning Gesture includes but is not limited to finger swipes along a single axis relative to Touchscreens as in FIG. 19, FIG. 20, FIG. 21 and FIG. 22, along a complex curve relative to Touchscreens as in FIG. 23 and FIG. 24, and any combination thereof such as an “X” motion as in FIG. 25. The fingers can be from either left, right or both hands, and can include the user's thumbs.

### Embodiment 103—Combined Panning and Rotating Gesture

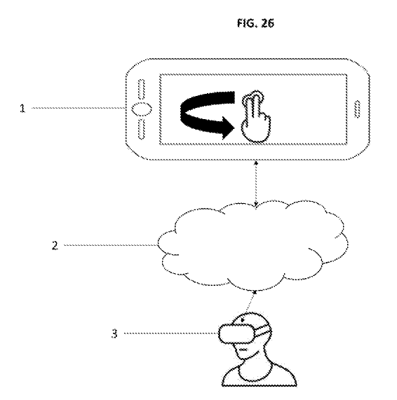

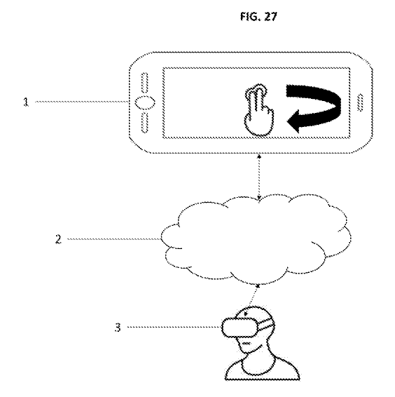

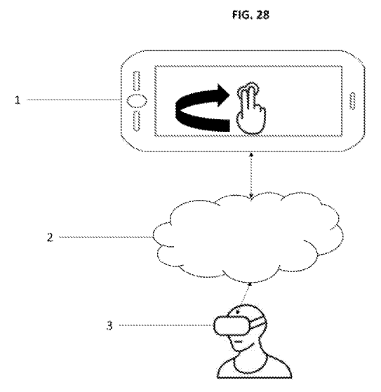

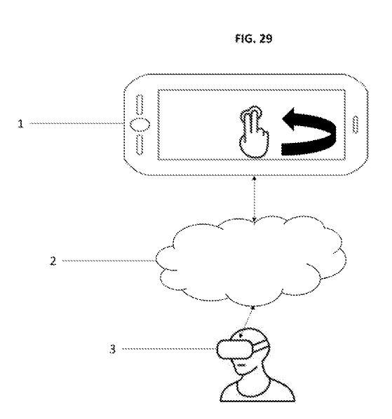

Referencing FIG. 26, FIG. 27, FIG. 28 and FIG. 29, the System enables Users to use two fingers touching one or more Touchscreens 1 to Manipulate one or more Devices 3 connected by network connections 2 via Bluetooth, Wi-Fi, cellular network or any other network to use two fingers on Touchscreens to pan and rotate what is displayed in Devices (“Combined Panning and Rotating Gesture”). The Combined Panning and Rotating Gesture includes but is not limited to two fingers swipes in a complex curved direction on Touchscreens, with the Device showing apparent rotating motion around what is being displayed in the Device while still facing towards what is being displayed in the Device, in a direction corresponding to the direction of the finger swipes on Touchscreens. The fingers can be from either left, right or both hands, and can include the user's thumbs.

### Embodiment 104—Rotating Swirl Gesture

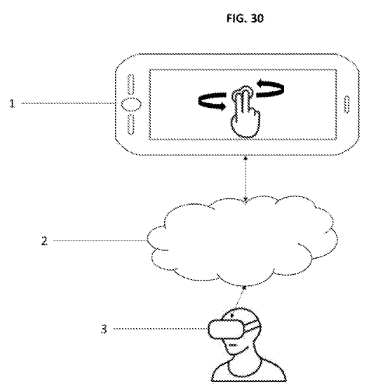

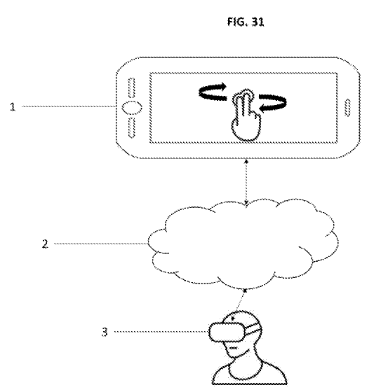

Referencing FIG. 30 and FIG. 31, the System enables Users to use one or two fingers touching one or more Touchscreens 1 to Manipulate one or more Devices 3 connected by network connections 2 via Bluetooth, Wi-Fi, cellular network or any other network to use two fingers rotating simultaneously or one finger rotating by itself clockwise or counterclockwise on Touchscreens to change what is displayed in Devices (“Rotating Swirl Gesture”). The Rotating Swirl Gesture includes but is not limited to two finger, simultaneous swipes or single finger swipes in clockwise or counterclockwise directions on Touchscreens, with the Device showing apparent clockwise or counterclockwise motion relative to what is being displayed in the Device in a direction corresponding to the direction of the finger swipes on Touchscreens. The fingers can be from either left, right or both hands, and can include the user's thumbs.

### Embodiment 105—Finger Wheel Gesture

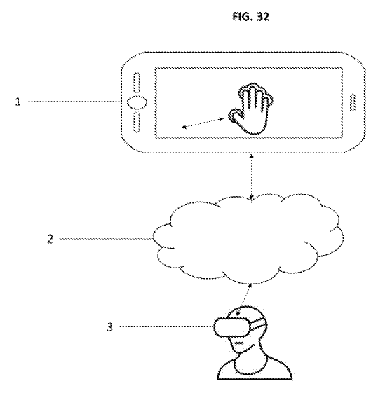

Referencing FIG. 32, the System enables Users to use two or more fingers touching one or more Touchscreens 1 to Manipulate one or more Devices 3 connected by network connections 2 via Bluetooth, Wi-Fi, cellular network or any other network to use two or more fingers with one or more finger static on Touchscreens and another finger swiping along one axis on Touchscreens to change what is displayed in Devices (“Finger Wheel Gesture”). The Finger Wheel Gesture includes but is not limited to using two or more fingers with one or more finger static on Touchscreens (“Static Fingers”) and another finger swiping along one axis on Touchscreens (“Swiping Finger”), with the Device displaying menus in the Device with the number of items in each menu corresponding to the number of Static Fingers on Touchscreens, and the items in the menu changing as the Swiping Finger swipes along Touchscreens or selections moving among choices of displayed items whether in a menu or otherwise. The fingers can be from either left, right or both hands, and can include the user's thumbs.

### Embodiments 200 to 210—Combined Touchscreen and Head Mounted Display (“HMD”) Gestures

### Embodiment 200—Static Touch and Dynamic HMD Gesture

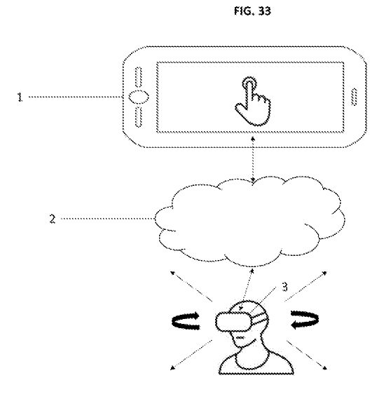

Referencing FIG. 33, the System enables Users to use one or more fingers touching one or more Touchscreens 1 to Manipulate one or more Devices including their Head Mounted Display (“HMD”) components 3 connected by network connections 2 via Bluetooth, Wi-Fi, cellular network or any other network to use one or more Static Fingers on static Touchscreens, and HMDs moving or turning in any direction to change what is displayed in Devices (“Static Touch and Dynamic HMD Gesture”). The Static Touch and Dynamic HMD Gesture includes but is not limited to using one or more Static Fingers on static Touchscreens, and one or more moving HMDs, with Devices displaying a complex curve movement of what is displayed in Devices corresponding to the movement of the HMDs and the position of the Static Fingers on Static Touchscreens. The fingers can be from either left, right or both hands, and can include the user's thumbs.

### Embodiment 201—Static Touch, Dynamic Touchscreen and Dynamic HMD Gesture

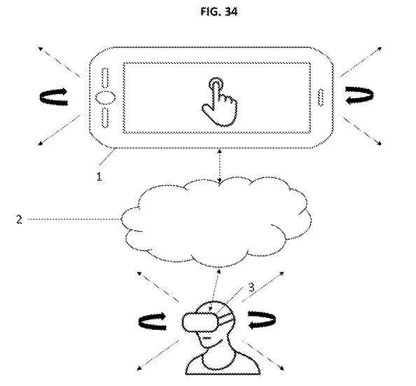

Referencing FIG. 34, the System enables Users to use one or more fingers touching one or more Touchscreens 1 to Manipulate one or more Devices including their Head Mounted Display (“HMD”) components 3 connected by network connections 2 via Bluetooth, Wi-Fi, cellular network or any other network to use one or more Static Fingers on moving Touchscreens, and HMDs moving or turning in any direction to change what is displayed in Devices (“Static Touch, Dynamic Touchscreen and Dynamic HMD Gesture”). The Static Touch, Dynamic Touchscreen and Dynamic HMD Gesture includes but is not limited to using one or more Static Fingers on moving Touchscreens, and one or more moving HMDs, with the Devices displaying a complex curve movement of what is displayed in Devices corresponding to the movement of Touchscreens and HMDs, and the position of the Static Fingers on moving Touchscreens. The fingers can be from either left, right or both hands, and can include the user's thumbs.

### Embodiment 202—Dynamic Touch and Dynamic HMD Gesture

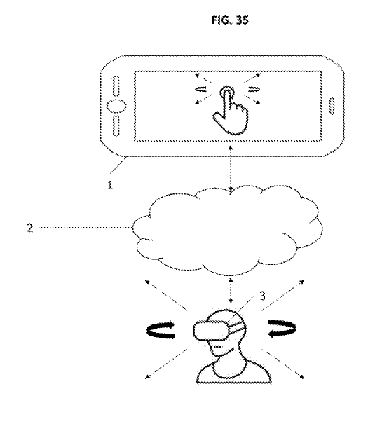

Referencing FIG. 35, the System enables Users to use one or more fingers touching one or more Touchscreens 1 to Manipulate one or more Devices including their Head Mounted Display (“HMD”) components 3 connected by network connections 2 via Bluetooth, Wi-Fi, cellular network or any other network to use one or more fingers on static Touchscreens, and HMDs moving or turning in any direction to change what is displayed in Devices (“Dynamic Touch and Dynamic HMD Gesture”). The Dynamic Touch and Dynamic HMD Gesture includes but is not limited to using one or more fingers on static Touchscreens, and one or more moving HMDs, with Devices displaying a complex curve movement of what is displayed in Devices corresponding to the movement of the HMDs and the movement of the fingers on Static Touchscreens. The fingers can be from either left, right or both hands, and can include the user's thumbs.

### Embodiment 203—Dynamic Touch, Dynamic Touchscreen and Dynamic HMD Gesture

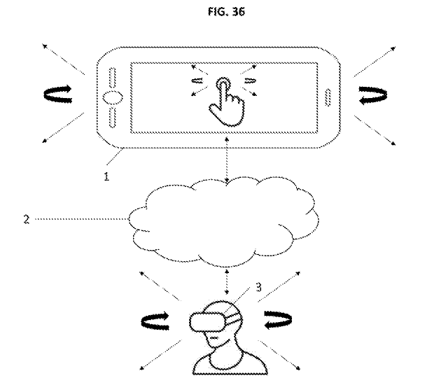

Referencing FIG. 36, the System enables Users to use one or more fingers touching one or more Touchscreens 1 to Manipulate one or more Devices including their Head Mounted Display (“HMD”) components 3 connected by network connections 2 via Bluetooth, Wi-Fi, cellular network or any other network to use one or more fingers on moving Touchscreens, and HMDs moving or turning in any direction to change what is displayed in Devices (“Dynamic Touch, Dynamic Touchscreen and Dynamic HMD Gesture”). The Dynamic Touch, Dynamic Touchscreen and Dynamic HMD Gesture includes but is not limited to using one or more fingers on moving Touchscreens, and one or more moving HMDs, with the Devices displaying a complex curve movement of what is displayed in Devices corresponding to the movement of fingers, Touchscreens and HMDs. The fingers can be from either left, right or both hands, and can include the user's thumbs.

### Embodiment 204—Dynamic Touch, Dynamic Touchscreen and Static HMD Gesture

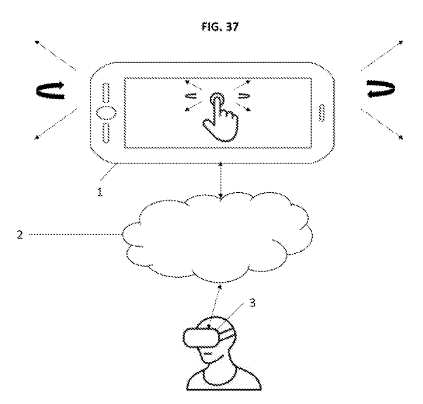

Referencing FIG. 37, the System enables Users to use one or more fingers touching one or more Touchscreens 1 to Manipulate one or more Devices including their Head Mounted Display (“HMD”) components 3 connected by network connections 2 via Bluetooth, Wi-Fi, cellular network or any other network to use one or more fingers on moving Touchscreens, and static HMDs to change what is displayed in Devices (“Dynamic Touch, Dynamic Touchscreen and Static HMD Gesture”). The Dynamic Touch, Dynamic Touchscreen and Static HMD Gesture includes but is not limited to using one or more fingers on moving Touchscreens, and one or more static HMDs, with the Devices displaying a complex curve movement of what is displayed in Devices corresponding to the movement of fingers and Touchscreens. The fingers can be from either left, right or both hands, and can include the user's thumbs.

### Embodiment 205—Static Touch

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Static Touch Gesture”). The Static Touch Gesture includes but is not limited to using one or more fingers static on Touchscreens. The fingers can be from either left, right or both hands, and can include the user's thumbs.

### Embodiment 206—Dynamic Touch

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Dynamic Touch Gesture”). The Dynamic Touch Gesture includes but is not limited to using one or more fingers moving on Touchscreens. The fingers can be from either left, right or both hands, and can include the user's thumbs.

### Embodiment 207—Static Touchscreen

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Static Touchscreen Gesture”). The Dynamic Touch Gesture includes but is not limited to using one or more static Touchscreens. The fingers can be from either left, right or both hands, and can include the user's thumbs.

### Embodiment 208—Dynamic Touchscreen

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Dynamic Touchscreen Gesture”). The Dynamic Touch Gesture includes but is not limited to using one or more moving Touchscreens. The fingers can be from either left, right or both hands, and can include the user's thumbs.

### Embodiment 209—Static Device

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Static Device Gesture”). The Static Device Gesture includes but is not limited to using one or more static Devices including their HMD components. The fingers can be from either left, right or both hands, and can include the user's thumbs.

### Embodiment 210—Dynamic Device

The System enables Users to use one or more fingers touching one or more Touchscreens to Manipulate one or more Devices including their HMD components connected by network connections via Bluetooth, Wi-Fi, cellular network or any other network to use one or more fingers on Touchscreens, and HMDs to change what is displayed in Devices (“Dynamic Device Gesture”). The Dynamic Device Gesture includes but is not limited to using one or more moving Devices including their HMD components. The fingers can be from either left, right or both hands, and can include the user's thumbs.

### Embodiments 300 to 306—Combination Touch Gestures and Other Inputs

### Embodiment 300—Combination Touch Gestures and Accelerometer

The System enables Users to use any of the other Embodiments in this application in combination with movement of accelerometers, whether incorporated in Touchscreens, Devices or otherwise (“Accelerometers”), to Manipulate one or more Devices connected by network connections via Bluetooth, Wi-Fi, cellular network or any other network.

### Embodiment 301—Combination Touch Gestures and Audio

The System enables Users to use any of the other Embodiments in this application in combination with audio inputs and outputs from and to microphones, speakers and any other audio input or output devices, whether via speech or any other sounds of any type, whether incorporated in Touchscreens, Devices or otherwise (“Audio Devices”), to Manipulate one or more Devices connected by network connections via Bluetooth, Wi-Fi, cellular network or any other network.

### Embodiment 302—Combination Touch Gestures and Gaze

The System enables Users to use any of the other Embodiments in this application in combination with inputs or outputs indicating the direction Users are looking, whether in terms of the direction Users' heads or eyes are facing, from and to sensors, whether positional, eye tracking or otherwise, and whether incorporated in Touchscreens, Devices or otherwise (“Gaze”), to Manipulate one or more Devices connected by network connections via Bluetooth, Wi-Fi, cellular network or any other network.

### Embodiment 303—Combination Touch Gestures and Controller

The System enables Users to use any of the other Embodiments in this application in combination with inputs or outputs from hardware controllers, including and not limited to buttons, joysticks, trackpads, computer mice, ribbon controllers and any other hardware controller device and whether incorporated in Touchscreens, Devices or otherwise (“Controller”), to Manipulate one or more Devices connected by network connections via Bluetooth, Wi-Fi, cellular network or any other network.

### Embodiment 304—Combination Touch Gestures and Non-Touch Gestures

The System enables Users to use any of the other Embodiments in this application in combination with inputs or outputs from sensors capable of interpreting non-touch gestures, including and not limited to gestures by any part of the human body or otherwise, whether incorporated in Touchscreens, Devices or otherwise (“Non-Touch Gesture”), to Manipulate one or more Devices connected by network connections via Bluetooth, Wi-Fi, cellular network or any other network.

### Embodiment 305—Combination Touch Gestures and Visual Inputs (such as Cameras)

The System enables Users to use any of the other Embodiments in this application in combination with inputs or outputs from sensors capable of capturing visual inputs, including and not limited to cameras, light sensors or otherwise, whether incorporated in Touchscreens, Devices or otherwise (“Visual Inputs”), to Manipulate one or more Devices connected by network connections via Bluetooth, Wi-Fi, cellular network or any other network.

### Embodiment 306—Combination Touch Gestures and Non-Visual Inputs (Such as Radar for Range Finding)

The System enables Users to use any of the other Embodiments in this application in combination with inputs or outputs from sensors capable of capturing non-visual inputs, including and not limited to radar, sonar, compass, accelerometer, Inertial Measurement Unit (“IMU”), Global Positioning System (“GPS”) or otherwise, whether incorporated in Touchscreens, Devices or otherwise (“Non-Visual Inputs”), to Manipulate one or more Devices connected by network connections via Bluetooth, Wi-Fi, cellular network or any other network.

### Embodiment 400—Touchscreen to Device Pairing and Control Via Networks

### Embodiment 400—Touchscreen to Device Pairing Via Networks (“Pairing”)

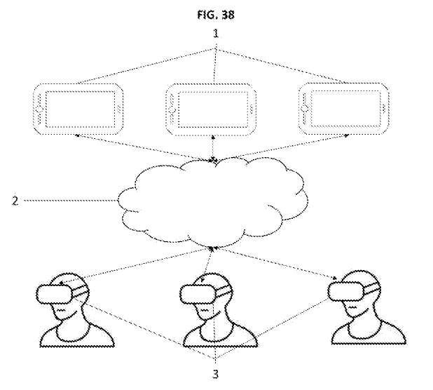

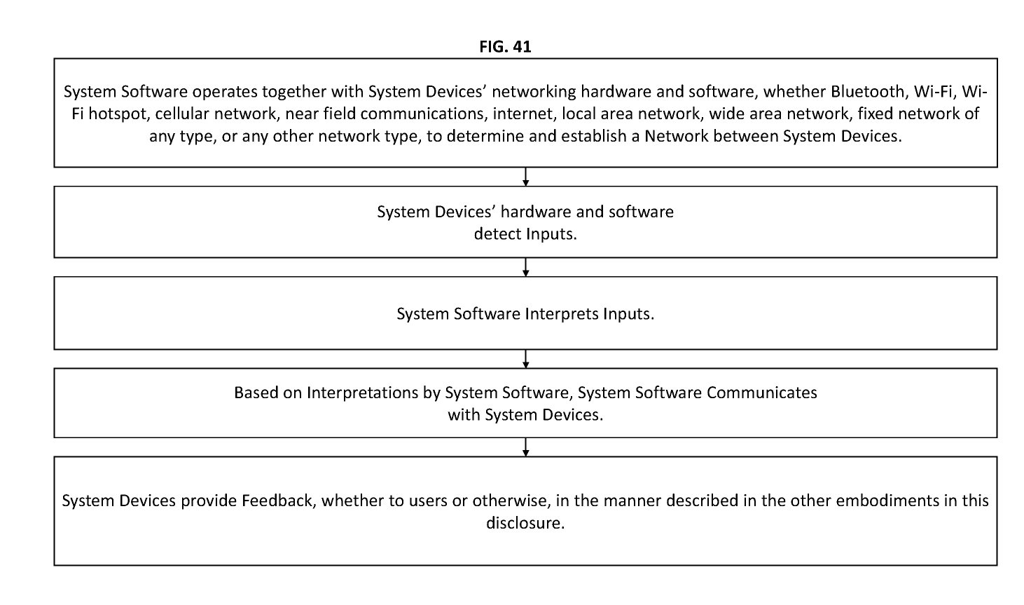

In this embodiment (“Pairing”), referencing FIG. 38 and FIG. 41, the System enables Touchscreens 1 to communicate with, connect with, interact with, control and transfer data between Devices 3 connected by network connections 2 via Bluetooth, Wi-Fi, Wi-Fi hotspot, cellular network, near field communications, internet, local area network, wide area network, fixed network of any type, or any other network (“Network” or “Networks”). The System enables multi-directional instructions, communications, connections, interactions, control, authentication and data transfer (“Communications”, “Communicates”, “Communicating”) between Touchscreens and Devices (“System Devices”), with System Devices able to send and receive data and instructions to and from other System Devices via data channels over Networks.

Pairing by the System includes but is not limited to software and data operating in any or all System Devices, whether stored in System Devices' RAM, ROM, accessed remotely by System Devices over Networks, or otherwise (collectively “System Software”) System Software receiving and sending user and System inputs and outputs from, to and between System Devices (“Feedback”), System Software using Feedback to determine what instructions and/or data, if any, to execute, send and/or receive across any or all System Devices and Networks (“Interpretation” or “Interpreting”), System Software sending and receiving Communications between and across System Devices and Networks either in response to Interpretation or otherwise, System Software Interpreting any and all Communications, System Software executing instructions on System Devices, Networks and/or otherwise, whether related to Communication, Interpretation or otherwise.

Pairing is enabled by System Software operating together with System Devices' networking hardware and software, whether Bluetooth, Wi-Fi, Wi-Fi hotspot, cellular network, near field communications, internet, local area network, wide area network, fixed network of any type, or any other network type, to determine and establish a Network between System Devices, System Devices' hardware and software detecting inputs as described in the other embodiments in this disclosure, whether from users or otherwise (“Inputs”), System Software Interpreting Inputs, based on Interpretations by System Software, System Software Communicating with System Devices, and System Devices providing Feedback, whether to users or otherwise, in the manner described in the other embodiments in this disclosure.

Pairing includes but is not limited to network optimization by the System to minimize latency within, between and across System Devices, whether by controlling data buffering, data packet sizes, flow of data between System Devices or otherwise, whether by choosing protocols and data payload sizes that maximize throughput and minimize delay, or any other method to reduce latency within, between and across System Devices and Networks. Communication, connection, interaction, authentication and data transfer by the System can be either guaranteed or non-guaranteed, with implementations that both do and do not ensure that dropped data does not introduce errors.

Pairing includes but is not limited to System Devices using client-server, peer-to-peer, or any other networking configuration. Pairing includes operation within and across different operating systems and System Devices of any type. Pairing includes implementation at the physical layer, data-linking layer, network layer, transportation layer, session layer, presentation layer, server application layer, client application layer and any other network or system architecture layer or level. Pairing includes management of System Device and Network data security. Pairing includes but is not limited to operating in distributed computing, Advanced Intelligent Network, dumb network, intelligent computer network, context aware network, peer-to-peer network, permanent virtual circuits and any other Network type, instance or implementation.

### Embodiment 401—Touchscreen and Device Control (“Control”)

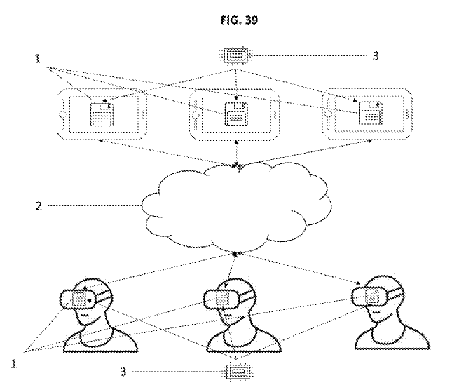

In this embodiment (“Control”), referencing FIG. 39, the System enables Touchscreens to control Devices, Devices to control Touchscreens, Devices to control Devices, Touchscreens to control Touchscreens, and/or any combination thereof (“Control”) by 1 System Software stored in, or accessed remotely via Networks by, Devices and/or Touchscreens, 2 establishing a Network between Devices and/or Touchscreens via Pairing as described in embodiment 400, 3 receiving user and other Inputs on Devices and/or Touchscreens as described in the other embodiments in this disclosure and/or otherwise, Devices and/or Touchscreens Interpreting those Inputs, where relevant, Devices and/or Touchscreens Communicating those Interpretations to other Devices and/or Touchscreens in the Network via Pairing, and based on those Interpretations, Devices and/or Touchscreens executing instructions, data transfer and other actions, whether in System Software stored in Devices and/or Touchscreens, remotely across Networks, or otherwise. For purposes of the discussion herein, those skilled in the art will appreciate that such System Software can include applications running on Touchscreens which, via servers or through direct or networked interaction with Devices and/or applications running on Devices, exchange commands and data between Devices and/or Touchscreens. A script or other program can be installed on Devices and/or Touchscreens, via Device and/or Touchscreen application program interfaces (“API” or “APIs”), allowing the exchange of commands and data between applications in Touchscreens and/or Devices. In some embodiments, Devices may include APIs that allow interaction with external devices, whether via Bluetooth, Wi-Fi, cellular mobile network or otherwise.

### Embodiments 500 to 512—Paired Touchscreen and Device Shared Operation

### Embodiment 500—Paired Touchscreen and Device Via Networks Accelerometer

The System enables Users to use any of the other Embodiments in this application in combination with Accelerometers to enable input from and feedback to Users.

### Embodiment 501—Paired Touchscreen and Device Via Networks Audio

The System enables Users to use any of the other Embodiments in this application in combination with Audio Devices to enable input from and feedback to Users.

### Embodiment 502—Paired Touchscreen and Device Via Networks Gaze

The System enables Users to use any of the other Embodiments in this application in combination with Gaze to enable input from and feedback to Users.

### Embodiment 503—Paired Touchscreen and Device via Networks Controller

The System enables Users to use any of the other Embodiments in this application in combination with Controllers to enable input from and feedback to Users.

### Embodiment 504—Combination Touch Gestures and Non-Touch Gestures

The System enables Users to use any of the other Embodiments in this application in combination with Non-Touch Gestures to enable input from and feedback to Users.

### Embodiment 505—Paired Touchscreen and Device via Networks Visual

The System enables Users to use any of the other Embodiments in this application in combination with Visual Inputs such as cameras, light sensors and otherwise to enable input from and feedback to Users.

### Embodiment 506—Paired Touchscreen and Device via Networks Non-Visual

The System enables Users to use any of the other Embodiments in this application in combination with Non-Visual Inputs such as radar, sonar, compass, accelerometer, IMU, GPS to enable input from and feedback to Users.

### Embodiment 507—Paired Touchscreen and Device via Networks Storage

The System enables Users to use any of the other Embodiments in this application in combination with data storage devices, including but not limited to RAM, ROM or otherwise, whether incorporated in Touchscreens, Devices or otherwise (“Storage”), to enable shared Storage between Touchscreens and Devices.

### Embodiment 508—Paired Touchscreen and Device via Networks Data Transfer

The System enables Users to use any of the other Embodiments in this application in combination with the transfer of data between Touchscreens and Devices by network connections via Bluetooth, Wi-Fi, cellular network or any other network (“Data Transfer”) to enable Data Transfer between Touchscreens and Devices.

### Embodiment 509—Paired Touchscreen and Device via Networks Co-Processing

The System enables Users to use any of the other Embodiments in this application in combination with shared operation of central processing units, graphics processing units, visual processing units or any other computer processing units whether incorporated in Touchscreens, Devices or otherwise (“Co-Processing”) to enable Co-Processing between Touchscreens and Devices.

### Embodiment 510—Paired Touchscreen and Device via Networks Security

The System enables Users to use any of the other Embodiments in this application in combination with security authentication of any type whether incorporated in Touchscreens, Devices or otherwise (“Security”) to enable shared Security between Touchscreens and Devices.

### Embodiment 511—Paired Touchscreen and Device via Networks Payment

The System enables Users to use any of the other Embodiments in this application in combination with payment processing of any type whether incorporated in Touchscreens, Devices or otherwise (“Payment”) to enable shared Payment between Touchscreens and Devices.

### Embodiment 512—Paired Touchscreen and Device via Networks Haptic

The System enables Users to use any of the other Embodiments in this application in combination with haptic input and feedback from haptic devices of any type whether incorporated in Touchscreens, Devices or otherwise (“Haptics”) to enable Haptics from and to Users between Touchscreens and Devices.

### Embodiment 513—Six Degrees of Freedom

The System enables Users to use any of the other Embodiments in this application in combination to enable multiple combinations of six degrees of freedom input, output, viewing and manipulation in three dimensional space as displayed in by Devices.

### Embodiments 600 to 603—Special Cases

### Embodiment 600—Mouse Emulation

The System enables Users to use Touchscreens to Manipulate Devices connected by network connections via Bluetooth, Wi-Fi, cellular network or any other network to simulate computer mouse functionality, with cursor control, input buttons, scroll wheels and other functions enabled by a computer mouse or trackpad.

### Embodiment 601—Keyboard Emulation

The System enables Users to use Touchscreens to Manipulate Devices connected by network connections via Bluetooth, Wi-Fi, cellular network or any other network to simulate computer keyboard functionality.

### Embodiment 601—Secondary Displays

The System enables Users to use Touchscreens to Manipulate Devices (C) connected by network connections via Bluetooth, Wi-Fi, cellular network or any other network to provide multiple display functionality.

### Embodiment 603—High Precision

The System enables Users to use Touchscreens to Manipulate Devices connected by network connections via Bluetooth, Wi-Fi, cellular network or any other network to increase/decrease the amount of movement needed on Touchscreens to cause corresponding movement on Devices to enable high precision control.

### Computer System

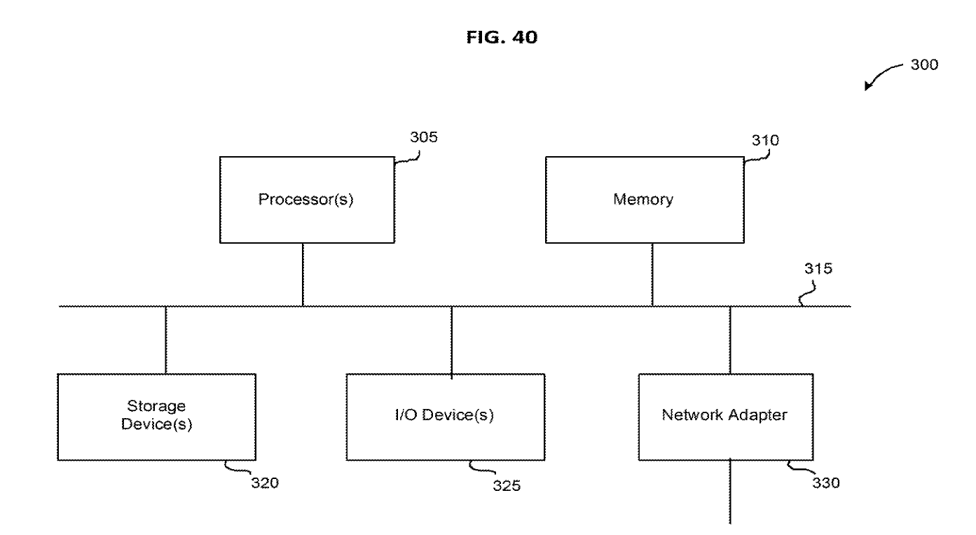

FIG. 40 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a smartphone, a tablet computer, a Blackberry, a processor, a telephone, a web appliance, a network router, switch or bridge, a console, a hand-held console, a (hand-held) gaming device, a music player, any portable, mobile, hand-held device, wearable device, a Touchscreen (as defined elsewhere in this disclosure), a Device (as defined elsewhere in this disclosure), or any machine capable of executing a set of instructions (sequential or otherwise) that specify actions to be taken by that machine.
The computing system 300 may include one or more central processing units (“processors”) 305, memory 310, input/output devices 325 (e.g., keyboard and pointing devices, touch devices, display devices), storage devices 320 (e.g., disk drives), and network adapters 330 (e.g., network interfaces) that are connected to an interconnect 315. The interconnect 315 is illustrated as an abstraction that represents any one or more separate physical buses, point to point connections, or both connected by appropriate bridges, adapters, or controllers. The interconnect 315, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.
The memory 310 and storage devices 320 are computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., non-transitory media) and computer-readable transmission media.
The instructions stored in memory 310 can be implemented as software and/or firmware to program the processor(s) 305 to carry out actions described above. In some embodiments, such software or firmware may be initially provided to the processing system 300 by downloading it from a remote system through the computing system 300 (e.g., via network adapter 330).
The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.
Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.
The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.
Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.
Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

I. A method of inputting instructions, with touchscreens connected by network connections to virtual reality devices, augmented reality devices and/or mixed reality devices to change said touchscreens' and/or said virtual reality devices', augmented reality devices' and/or mixed reality devices' operation, comprising:
a recording user inputs with said touchscreens and/or said virtual reality devices, augmented reality devices and/or mixed reality devices,
b changing the operation of said touchscreens and/or said virtual reality devices, augmented reality devices and/or mixed reality devices,
c changing what is displayed by said touchscreens and/or said virtual reality devices, augmented reality devices and/or mixed reality devices, including movement through virtual environments and/or of virtual objects, and/or,
d providing visual, audio, haptic and/or other feedback via said touchscreens and/or said virtual reality devices, augmented reality devices and/or mixed reality devices,

II. The method of claim I, wherein the configuration of said touchscreens and said virtual reality devices, augmented reality devices and/or mixed reality devices are in one to one, one to many, many to one and many to many configurations,

III. The method of claim I, wherein the instructions are input using between one and ten fingers, using fingers from either left, right or both hands, including thumbs,

IV. The method of claim I, wherein a touchpad is used in the place of said touchscreen,

V. The method of claim I, wherein the instructions input from said touchscreens and said virtual reality devices, augmented reality devices and/or mixed reality devices, include one or more of a walking gesture, b turning gesture, c panning turning, scrolling or selection gesture, d combined panning and rotating gesture, and/or e rotating swirl gesture and/or e finger wheel gesture,

VI. The method of claim I, wherein the instructions input from said touchscreens and said virtual reality devices, augmented reality devices and/or mixed reality devices, include one or more of a static touch and dynamic hmd gesture, b static touch, dynamic touchscreen and dynamic hmd gesture, c dynamic touch and dynamic hmd gesture, d dynamic touch, dynamic touchscreen and dynamic hmd gesture, e dynamic touch, dynamic touchscreen and static hmd gesture, f static touch gesture, g dynamic touch gesture, h static touchscreen gesture, i dynamic touchscreen gesture, j static device gesture, and/or k dynamic device gesture,

VII. The method of claim I, wherein the instructions input from said touchscreens and said virtual reality devices, augmented reality devices and/or mixed reality devices, are combined with other inputs, including one or more of a accelerometer, b audio devices, c gaze, d controller, e non-touch gestures, f visual Inputs, including but not limited to cameras, and/or g non-visual inputs, including but not limited to radar for range finding,

VIII. The method of claim I, wherein said touchscreens and said virtual reality devices, augmented reality devices and/or mixed reality devices are connected and controlled via networks using a pairing and b control,

IX. The method of claim I, wherein said touchscreens and said virtual reality devices, augmented reality devices and/or mixed reality devices share operations, including one or more of a paired touchscreen and device via networks accelerometer, b paired touchscreen and device via networks audio, c paired touchscreen and device via networks gaze, d paired touchscreen and device via networks controller, e combination touch gestures and non-touch gestures, f paired touchscreen and device via networks visual, g paired touchscreen and device via networks non-visual, h paired touchscreen and device via networks storage, i paired touchscreen and device via networks data transfer, j paired touchscreen and device via networks co-processing, k paired touchscreen and device via networks security, l paired touchscreen and device via networks payment, m paired touchscreen and device via networks haptic, and/or n six degrees of freedom,

X. The method of claim I, wherein said touchscreens and said virtual reality devices, augmented reality devices and/or mixed reality devices, enable input of one or more of a mouse emulation, b keyboard emulation, c secondary displays, and/or d high precision.
